(19) United States
(12) Patent Application Publication
(10) Pub. No.: US 2013/0026885 A1
(43) Pub. Date: Jan. 31, 2013

(54) ULTRASONIC SENSOR

(71) Applicants: Boum Seock Kim, Gyeonggi-do (KR); Eun Tae Park, Gyeonggi-do (KR)

(72) Inventors: Boum Seock Kim, Gyeonggi-do (KR); Eun Tae Park, Gyeonggi-do (KR)

(73) Assignee: SAMSUNG ELECTRO-MECHANICS CO., LTD., Suwon (KR)

(21) Appl. No.: 13/493,530

(22) Filed: Jun. 11, 2012

(30) Foreign Application Priority Data
Jul. 27, 2011 (KR) 10-2011-0074591

(51) Int. Cl. G10K 9/122

(52) U.S. Cl. 310/327

(57) ABSTRACT

An ultrasonic sensor includes a case having an inner space provided therein, and having an upper stepped part and a lower stepped part respectively provided at an upper part and a lower part on an inside wall surface thereof; a piezoelectric element seated on a bottom surface of the case; a sound absorbent fixed above the piezoelectric element, a lateral portion of the sound absorbent being seated on the lower stepped part; and a substrate fixed above the sound absorbent, and configurated in a cross (+) shape of which respective lateral portions are seated on the upper stepped part.

### CROSS REFERENCE(S) TO RELATED APPLICATIONS

This application claims the benefit under 35 U.S.C. Section 119 of Korean Patent Application Serial No. 10-2011-0074591, entitled “Ultrasonic Sensor” filed on Jul. 27, 2011, which is hereby incorporated by reference in its entirety into this application.

### BACKGROUND OF THE INVENTION

1. Technical Field

The present invention relates to an ultrasonic sensor, and more particularly, to an ultrasonic sensor capable of providing stable coupling between a piezoelectric element and a substrate, by forming stepped parts on an inside wall surface of a case.

2. Description of the Related Art

In general, two kinds of ultrasonic sensors mainly used are a piezoelectricity type and a magnetrostriction type. The piezoelectricity type uses a phenomenon in which voltage is induced when pressure is applied to an object, such as crystal, PTZ (piezoelectric material), a piezoelectric polymer, or the like, and vibration is induced when voltage is applied to the object. The magnetrostriction type uses Joule effect (in which vibration occurs when a magnetic field is applied) and Villari effect (in which a magnetic field is generated when stress is applied), which are exhibited in an alloy of iron, nickel, and cobalt, or the like.

An ultrasonic element may be referred to as an ultrasonic sensor and an ultrasonic generator. As for the piezoelectricity type, ultrasonic waves are generated by vibration generated when voltage is applied to the piezoelectric element and ultrasonic waves are sensed by voltage generated when ultrasonic vibration is applied to the piezoelectric element. As for the magnetrostriction type, ultrasonic waves are generated by Joule effect and ultrasonic waves are sensed by Villari effect.

An ultrasonic sensor currently and generally used employs the piezoelectricity type using a piezoelectric element, and has a structure in which a piezoelectric element is seated within a case and ultrasonic waves generated from this piezoelectric element are emitted to the outside through the case. In the ultrasonic sensor having this structure, the case functions as an electrode of the piezoelectric element. Therefore, the case is made of a conductive material and the piezoelectric element and the case are adhered to each other by a conductive adhesive while they are electrically connected to each other.

In addition, the general ultrasonic sensor facilitates the emission of ultrasonic vibration of the piezoelectric element to the outside, by disposing the piezoelectric element on a bottom surface of the case, sequentially stacking a non-woven fabric and a substrate above the piezoelectric element, and fixing the non-woven fabric and the substrate by using a molding material to an inside of the case. However, since there are no separate fixing units at the time of assembling the substrate and the non-woven fabric, the assembling automation is difficult and the assembling time is lengthened.

### SUMMARY OF THE INVENTION

An object of the present invention is to provide an ultrasonic sensor in which a substrate and a non-woven fabric are stably coupled with each other by at least one stepped part formed on an inside wall surface of a case having a piezoelectric element embedded therein.

According to an exemplary embodiment of the present invention, there is provided an ultrasonic sensor, including: a case having one or more stepped parts provided on an inside wall surface thereof; a piezoelectric element seated on a bottom surface of the case; a sound absorbent fixed above the piezoelectric element, a lateral portion of the sound absorbent being seated on one of the stepped parts; and a substrate fixed above the sound absorbent, and configurated in a cross (+) shape of which respective lateral portions are seated on another of the stepped parts.

The ultrasonic sensor may further include a molding material injected and hardened within the case to fix the sound absorbent and the substrate.

The molding material may be injected through an empty space between the case and the substrate after the piezoelectric element, the sound absorbent, and the substrate are sequentially inserted within the case. Therefore, the molding material can be easily injected.

Here, a bottom surface of the case, within which the piezoelectric element is mounted, may be sealed by the piezoelectric element, so that infiltration of the molding material is prevented, thereby preventing ultrasonic vibration ability of the piezoelectric element form being decreased.

The stepped part, on which the substrate is seated, among the stepped parts provided within the case, may have parts having different heights with respect to a bottom surface of the case, so that a soldered portion is directly contacted with the case, thereby achieving conduction between the substrate and the case by merely seating the substrate on the stepped part.

The ultrasonic sensor may further include a first lead line and a second lead line led-in from an outside of the case to electrically connect the piezoelectric element, the substrate, and the case, respectively.

### BRIEF DESCRIPTION OF THE DRAWINGS

FIG. 1 is a perspective view of an ultrasonic sensor according to the present invention;

FIG. 2 is a cross-sectional view of the ultrasonic sensor according to the present invention;

FIG. 3 is a perspective view of a substrate employed in the ultrasonic sensor of the present invention; and

FIG. 4 is a plan view of the ultrasonic sensor of the present invention.

### DESCRIPTION OF THE PREFERRED EMBODIMENTS

The acting effects and technical configuration with respect to the objects of an ultrasonic sensor according to the present invention will be clearly understood by the following description in which exemplary embodiments of the present invention are described with reference to the accompanying drawings.

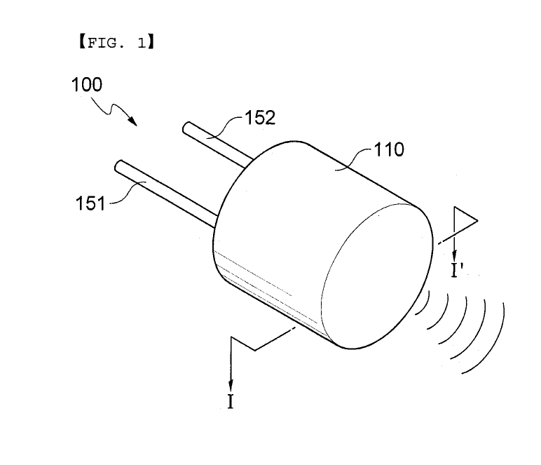

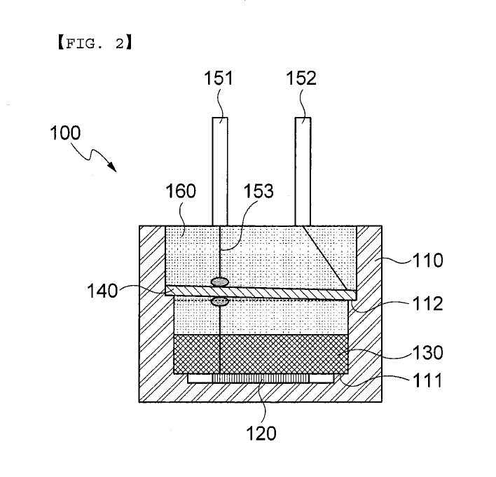

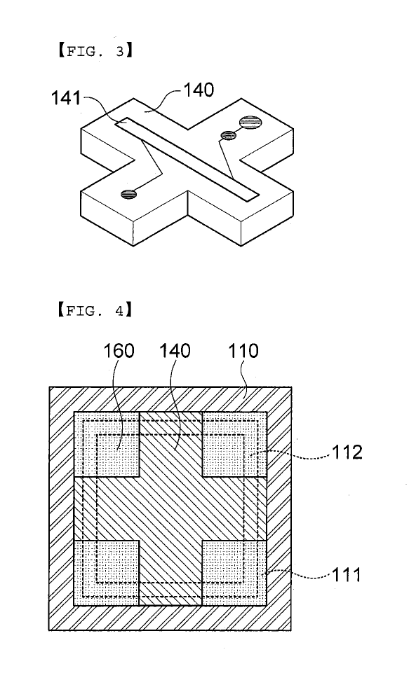

FIG. 1 is a perspective view of an ultrasonic sensor according to the present invention; FIG. 2 is a cross-sectional view of the ultrasonic sensor according to the present invention; FIG. 3 is a perspective view of a substrate employed in the ultrasonic sensor of the present invention; and FIG. 4 is a plan view of the ultrasonic sensor of the present invention.

As shown in the drawings, an ultrasonic sensor 100 according to an exemplary embodiment of the present invention may include a case 110 having one or more stepped parts 111 and 112, and a piezoelectric element 120, a sound absorbent 130, and a substrate 140, which are inserted and fixed within the case 110.

Here, the ultrasonic sensor 100 of the present invention may further include a first lead line 151 and a second lead line 152, which are led-in from an outside of the case 110. The two lead lines 151 and 152 are electrically connected to an electric power and an external device. The electric power is applied to the ultrasonic sensor 100 through the lead lines 151 and 152 to generate vibration of the piezoelectric element 120. Ultrasonic waves are generated from the piezoelectric element 120, reflected from an object to be measured, and then returned to the piezoelectric element 120. A voltage generated herein is transmitted to the external device through the lead lines 151 and 152.

The case 110 may be configurated in a cylindrical shape or a box shape, and made of a conductive material. The case 110 also may have a space in which a plurality of components are containable.

One or more, preferably, two stepped parts 111 and 112 may be provided at an upper part and a lower part on an inside wall surface of the case 110, respectively. The sound absorbent 130 and the substrate 140 may be individually seated on the stepped parts 111 and 112, respectively.

The piezoelectric element 120 may be installed on the bottom surface of the case 110. The piezoelectric element 120 maybe seated on the stepped part 111 formed at the lower part of the case 110, and may be closely coupled with the case 110 through the adhesive. Here, a conductive adhesive is preferably used in order to electrically connect to the piezoelectric element 120 to the case 110.

The piezoelectric element 120 is electrically connected to the power source through the first lead line 151, and thus, when current is applied to the piezoelectric element 120, longitudinal displacement thereof occurs, resulting in vibrational ultrasonic waves. Here, the piezoelectric element 120 is extended or contracted depending on the polarity of current applied through the first lead line 151. When polarity of the current is repeatedly altered, the piezoelectric element 120 is repeatedly extended and contracted, thereby generating vibration due to this trembling. Through this principle, the ultrasonic waves are generated in the piezoelectric element 120.

The sound absorbent 130 commonly made of a non-woven fabric is disposed above the piezoelectric element 120. The sound absorbent 130 is closely contacted with the piezoelectric element 120, and functions to reduce reverberation that occurs after generation of ultrasonic waves of the piezoelectric element 1200.

The reason why the reverberation of the piezoelectric element 120 is reduced through the sound absorbent 30 is that, since the piezoelectric element 120 simultaneously performs a function of generating ultrasonic waves and a function of sensing ultrasonic waves, which are emitted to the outside, reflected from the object to be measured, and then returned, the reverberation after generation of ultrasonic waves needs to be completely removed so that the reflected ultrasonic waves can be easily sensed and the sensing time can be shortened.

In addition, a lateral portion of the sound absorbent 130 is seated on the stepped part 111 formed on a lateral surface at the place where the piezoelectric element 120 is seated, thereby preventing a molding material 160 from infiltrating into the vicinity of the piezoelectric element 120 at the time of injecting the molding material 160 within the case 110.

In the piezoelectric element 120, as mentioned above, vibration is generated by longitudinal extension and contraction that occurs due to the application of current. When the molding material 160 fills around the piezoelectric element 120, it is difficult to generate vibration due to the longitudinal extension and contraction of the piezoelectric element 120, and thus, it maybe difficult to generate ultrasonic waves having a frequency at which the sensor can be sensed the sensor. Therefore, it is preferable to prevent the molding material 160 from infiltrating into the vicinity of the piezoelectric element 120.

Meanwhile, the substrate 140 may be seated above the sound absorbent 130 with a predetermined space therebetween.

A lateral portion of the substrate 140 may be seated and fixed on the other stepped part 112 formed within the case 110. The substrate 140 is configurated in a cross (+) shape, and is inserted within the case 110 while a temperature compensating capacitor 141 is mounted on an upper surface of the substrate.

Here, the stepped part 112 may be formed on the entire inside wall surface of the case 110, or at least four portions of the stepped part 112 may be formed at a predetermined interval therebetween depending on the shape of the substrate 140 such that lateral portions of the cross (+) shape can be seated.

The molding material 160 is injected through a space between the case 110 and the substrate 140, which is generated due to the cross (+) shape of the substrate 140. The molding material 160 is injected up to an upper end of the case 110 while the molding material is stacked from the upper surface of the sound absorbent 130. Then the molding material 160 is hardened so that the sound absorbent 130, the substrate 140, and a pair of connection lines 153 connected to a pair of lead lines 151 and 152 can be fixed at predetermined locations, and can be protected from external impact or shaking.

In addition, the stepped part 112, which is formed at the upper part of the case 110 to seat the substrate 140 thereon, may have different heights with respect to the bottom surface of the case at left and right sides thereof. In other words, the substrate 140 is seated on the stepped part 112 such that one side of the substrate 140 is somewhat slopingly mounted. As such, the substrate 140 can be seated on the stepped part 112 and conduction between the substrate 140 and the case 110 can be achieved without separate soldering after the substrate 140 is seated, by merely hanging and fixing the substrate 140 on the stepped part 112 such that the substrate 140 is artificially sloped.

The substrate 140 seated within the case 110 generally needs to be electrically conducted to the case by soldering one side of the substrate 140 and a lateral surface of the case 110 contacted with the substrate. However, when heights of parts of the stepped part 112 are made to be different and the substrate 140 is positioned on the stepped part after the lower surface of the substrate 140 is partially soldered in advance, the soldered portion is positioned on the stepped part 112, thereby achieving conduction between the substrate 140 and the case 110 without a separate soldering process.

Meanwhile, the piezoelectric element 120 seated on the bottom surface of the case 110 has a capacitance value changeable depending on the external temperature. This change in the capacitance value causes reverberation of the piezoelectric element 120 to be increased at a low temperature (−40□ or lower), resulting in malfunction of the systems, and causes sensitivity of the piezoelectric element 120 to be deteriorated at a high temperature (80□ or higher), thereby decreasing a sensing distance.

In order to prevent the piezoelectric element 120 from being defective due to change of external temperature, the temperature compensating capacitor 141 is used to compensate the change in the capacitance value of the piezoelectric element 120. The temperature compensating capacitor 141 is mounted on the upper surface of the substrate 140. Electric connection between the substrate 140 and the temperature compensating capacitor 141 is made through the connection lines connected to the lead line 151.

Here, the first lead line 151 is led-in from the outside of the case 110, and electrically connected to the substrate 140 on which the temperature compensating capacitor 141 is mounted, and the piezoelectric element 120. The second lead line 152 is led-in from the outside of the case 110, and electrically connected to a rear surface of the substrate 140 and a lateral wall of the case 110.

As such, after a plurality of components are inserted and fixed within the case 110, the molding material 160 is injected through interspaces of the substrate 140 and then hardened, thereby completing the manufacture of the ultrasonic sensor 100. Here, the molding material 160 functions to fix and protect a plurality of components within the case 110.

As set forth above, the ultrasonic sensor according to the present invention can prevent a molding material from infiltrating into the vicinity of the piezoelectric element and stably fix the substrate and the sound absorbent, by respectively fixing the sound absorbent and the substrate through one or more stepped parts formed on the inside wall surface of the case, thereby facilitating an assembling process and improving the working speed.

Furthermore, the present invention can easily inject a molding material filling between the sound absorbent and the substrate within the case, by configurating the substrate inserted within the case in a cross (+) shape, and can improve the assembling convenience by differentiating the heights of parts of the stepped part on which the substrate is seated, to allow the substrate and the case to be electrically conducted without separate soldering.

While the present invention has been shown and described in connection with the embodiments, it will be apparent to those skilled in the art that modifications and variations can be made without departing from the spirit and scope of the invention as defined by the appended claims.

What is claimed is:

1. An ultrasonic sensor, comprising:
a case having an inner space provided therein, and having an upper stepped part and a lower stepped part respectively provided at an upper part and a lower part on an inside wall surface thereof;
a piezoelectric element seated on a bottom surface of the case;
a sound absorbent fixed above the piezoelectric element, a lateral portion of the sound absorbent being seated on the lower stepped part; and
a substrate fixed above the sound absorbent, and configurated in a cross (+) shape of which respective lateral portions are seated on the upper stepped part.

2. The ultrasonic sensor according to claim 1, further comprising a molding material injected and hardened within the case to fix the sound absorbent and the substrate.

3. The ultrasonic sensor according to claim 1, wherein the sound absorbent is coupled on the lower stepped part and the substrate is coupled on the upper stepped part.

4. The ultrasonic sensor according to claim 3, wherein parts of the upper stepped part have different heights with respect to a bottom surface of the case.

5. The ultrasonic sensor according to claim 1, further comprising a first lead line and a second lead line led-in from an outside of the case to electrically connect the piezoelectric element, the substrate, and the case, respectively.

6. The ultrasonic sensor according to claim 3, wherein the piezoelectric element is seated on and closely adhered to an inside of the lower stepped part of the case using a conductive adhesive, for electric connection with the case.

7. The ultrasonic sensor according to claim 5, wherein the substrate has a temperature compensating capacitor mounted thereon, the substrate and the temperature compensating capacitor being electrically connected through connection lines connected with the first lead line.
